(19) United States
(12) Patent Application Publication
(10) Pub. No.: US 2025/0178905 A1
(43) Pub. Date: Jun. 5, 2025

(54) POSITIVE ELECTRODE MATERIAL AND PREPARATION METHOD THEREOF

(71) Applicant: SVOLT ENERGY TECHNOLOGY CO., LTD., CHANGZHOU (CN)

(72) Inventors: HAIPENG REN, CHANGZHOU (CN); WEIJUN JIANG, CHANGZHOU (CN); SIXIAN CHEN, CHANGZHOU (CN); XIAOXING ZHENG, CHANGZHOU (CN); LEIMING HAO, CHANGZHOU (CN); HONGXIN YANG, CHANGZHOU (CN); FEI GAO, CHANGZHOU (CN)

(73) Assignee: SVOLT ENERGY TECHNOLOGY CO., LTD., CHANGZHOU (CN)

(21) Appl. No.: 18/843,705

(22) Filed: Sep. 4, 2024

Related U.S. Application Data
(63) Continuation of application No. PCT/CN2023/096086, filed on May 24, 2023.

(51) Int. Cl. C01B 25/45

(52) U.S. Cl. CPC C01B 25/45; C01P 2002/01; C01P 2002/72; C01P 2004/03; C01P 2004/04; C01P 2004/34; C01P 2004/61; C01P 2004/84; C01P 2006/12; C01P 2006/16; C01P 2006/40

(57) ABSTRACT

The present application relates to the field of sodium ion battery materials, in particular to a positive electrode material and a preparation method thereof. The positive electrode material includes polyanion sodium iron salt and graphene coated on the polyanion sodium iron salt, and the positive electrode material is a hollow porous structure. The hollow porous structure cooperates with the graphene coated on the polyanion sodium iron salt, such that the positive electrode material has significantly improved charge-discharge performance and cycle stability.

### CROSS-REFERENCE OF RELATED APPLICATION

This application claims the priority to Chinese patent application No. 202210594559.6, entitled “positive electrode material and preparation method thereof”, filed to China National Intellectual Property Administration on May 27, 2022. The entirety of the above-mentioned patent application is hereby incorporated by reference herein and made a part of this specification.

### TECHNICAL FIELD

The present application relates to the field of sodium ion battery materials, in particular to a positive electrode material and a preparation method thereof.

### BACKGROUND

With the rapid development of new energy industry, lithium-ion batteries play an extremely important role in energy storage and power batteries. Due to a low distribution and content of lithium resources in the earth's crust, the price of lithium salts has risen rapidly, leading to a rapid increase of the cost of raw materials. However, due to an abundant resources of sodium and a low manufacturing cost for sodium-ion batteries, the sodium-ion batteries will be the main energy storage tools later in the development of the new energy industry. At present, although some considerable achievements have been made in the research of sodium-ion batteries, there are still many problems that need further research, especially the positive electrode materials of sodium-ion batteries.

Currently, there are two main types of positive electrode materials for sodium-ion batteries, one is metal oxide type, and the other is polyanion type. The polyanion type has attracted wide attention for its high electrode potential, strong structural framework, good thermal stability and fast sodium ion deintercalation kinetics. Among them, a sodium iron-based polyanion materials have great advantages in the pursuit of large-scale production, cost-effective and environmentally friendly positive electrode materials for sodium-ion batteries, due to an abundant reserves of raw material iron, a low price and simple material preparation process, which is expected to become a new generation of battery materials. However, its capacity and cycle stability need to be further improved.

### SUMMARY

The technical problem to be solved by the present application is to overcome the defects of low capacity and poor cycle stability in the related art, and provide a positive electrode material and a preparation method thereof.

To this end, the present application provides a positive electrode material, the positive electrode material includes a polyanion sodium iron salt and graphene coated on the polyanion sodium iron salt, and the positive electrode material is a hollow porous structure.

Further, the positive electrode material is a hollow porous spherical structure, preferably, the positive electrode material has an inner diameter of 0.5-9 μm and a wall thickness of 1-13 μm, more preferably, the positive electrode material has an inner diameter of 1-5 μm and a wall thickness of 2-5 μm.

Further, the positive electrode material has a pore diameter of 50-500 nm, a porosity of 3-18%, and a specific surface area of 5-40 m²/g, preferably, the positive electrode material has a pore diameter of 100-300 nm, a porosity of 5-12%, and a specific surface area of 10-30 m²/g.

Further, the pore diameter a, the porosity b, and the specific surface area c of the positive electrode material satisfy a relational formula below: 200<a×c/b<800. Further, the polyanion sodium iron salt has a molecular formula: NaₓFe_{y}M_{q}Bᵣ(AOn)_{z}(P₂O₇)ₘ, where M is at least one selected from the group consisting of Ti, V, Mn, Fe, Co, Ni, Cu and Zn, A is one selected from the group consisting of silicon, phosphorus, sulfur, carbon and boron, B is at least one selected from the group consisting of La, Ce, Pr, Nd, Pm, Sm, Eu, Gd, Td, Dy, Er, Tm, Yb, Lu, Sc, and Y, where 2≤x≤4, 0.5≤y≤3, 0≤q≤2, 0≤r≤0.3, and y+q+r≤3, 0≤z≤3, 0≤m≤3, 1≤n≤4, and z and m are not 0 at the same time, and a chemical formula satisfies charge conservation; preferably, M is Mn, B is La, and A is P.

Further, the polyanion sodium iron salt has a molecular formula: NaₓFe_{y}Mn_{q}Laᵣ(PO₄)_{z}(P₂O₇)ₘ, where 3≤x≤4, 1.5≤y≤2, 1≤q≤1.5, 0.2≤r≤0.3, and y+q+r≤3, 1≤z≤2, 1≤m≤2.

Further, a mass of the graphene accounts for 1%-20% of a total mass of the positive electrode material.

The present application further provides a preparation method for the positive electrode material, including the following steps:
Step S1: mixing carbon spheres with water to obtain a base solution, adding an anion source, an alkaline solution and a metal solution containing an iron salt to the base solution to perform a precipitation reaction, and adding a sodium salt to obtain a precursor solution;
Step S2: disposing the graphene in a vacuum environment to obtain a graphene film, and electrospraying the precursor solution onto the graphene film, and calcining the graphene film, to obtain the positive electrode material with a hollow porous structure.

In particular, the iron salt is a conventional iron salt in the art, for example, at least one of ferrous sulfate, ferric ammonium sulfate, ferrous ammonium sulfate, ferrous oxalate, ferric ammonium oxalate, ferrous chloride, ferric citrate, ferric ammonium citrate, ferric phosphate and ferric nitrate.

Further, in step S2, the electrospraying has a feeding rate of 4-10 mL/h, a spraying voltage of 10-20 kV, a nozzle diameter of 8-12 μm, and a discharging temperature of 50-90° C.; and/or the calcining is performed at a temperature of 300-800° C. for a period of 5-30 h.

Further, the calcining is carried out by heating up to 350-450° C. at a heating rate of 0.5-2° C./min in a nitrogen atmosphere, maintaining a temperature of 350-450° C. and calcining for 3-5 h, then heating up to 650-850° C. at a heating rate of 0.5-2° C./min, and maintaining a temperature of 650-850° C. and calcining for 5-20 h, preferably, the calcining is carried out by heating up to 380-420° C. at a heating rate of 0.8-1.5° C./min in a nitrogen atmosphere, maintaining a temperature of 380-420° C. and calcining for 3-5 h, then heating up to 680-720° C. at a heating rate of 0.8-1.5° C./min, and maintaining a temperature of 680-720° C. and calcining for 8-12 h.

Further, step S1 further satisfies at least one of the following (1)-(8):
(1) the metal solution further includes M salt and/or B salt; preferably, M is at least one selected from the group consisting of Ti, V, Mn, Fe, Co, Ni, Cu and Zn; B is at least one selected from the group consisting of La, Ce, Pr, Nd, Pm, Sm, Eu, Gd, Td, Dy, Er, Tm, Yb, Lu, Sc and Y; more preferably, M is Mn, and B is La;
(2) the anion source is at least one selected from the group consisting of silicon source, phosphorus source, sulfur source, carbon source and boron source; preferably, the anion source is at least one selected from the group consisting of ammonium dihydrogen phosphate, diammonium hydrogen phosphate, triammonium phosphate, phosphoric acid, sodium dihydrogen phosphate, disodium hydrogen phosphate, ammonium sodium hydrogen phosphate, pyrophosphoric acid, sodium pyrophosphate, hypophosphorous acid, ammonium hydrogen carbonate, ammonium sulfate, ammonium borate and ammonium silicate;
(3) during the precipitation reaction, further including a step of adding a protonic acid to the base solution; the anion source is phosphorus source;
preferably, a ratio of a molar amount of phosphate ions in the phosphorus source added in the base solution to a molar amount of hydrogen ions in the protonic acid to a total molar amount of metal elements added in the base solution is 2-4:1-8:1-3, more preferably 2-4:1-2:1-3;
taking ammonium dihydrogen phosphate and citric acid (protonic acid) as an example, there is 1 molecule of phosphate in 1 molecule of ammonium dihydrogen phosphate, and 1 molecule of citric acid is electrolyzed to generate 2 molecules of hydrogen ions;
(4) during the precipitation reaction, a pH value of a reaction solution is controlled to be 2 to 5, preferably 2.2 to 3.2; during the precipitation reaction, a stirring speed is controlled to be 500 to 1000 rpm, preferably 600 to 800 rpm; during the precipitation reaction, a temperature of the reaction solution is controlled to be 70 to 110° C., preferably 80 to 100° C.;
(5) the carbon spheres have a particle size of 0.5-8.0 μm, preferably 1-4 μm;
(6) the metal solution has a concentration of 0.5-3 mol/L, preferably 0.6-1.5 mol/L; the anion source has a concentration of 0.5-3 mol/L; the metal solution and the anion source are added dropwise to the base solution at a dropping rate of 60-400 mL/h, a time period for a dropwise reaction is 5-60 h, preferably 10-30 h;
(7) the alkaline solution is ammonia water, preferably, the ammonia water has a concentration of 0.5-1.5 mol/L;
(8) the base solution has a concentration of 50-200 g/L.

In particular, the protic acid is at least one selected from the group consisting of citric acid, oxalic acid, lactic acid and boric acid; the phosphorus source is at least one selected from the group consisting of ammonium dihydrogen phosphate, diammonium hydrogen phosphate, triammonium phosphate, phosphoric acid, sodium dihydrogen phosphate, disodium hydrogen phosphate, ammonium sodium hydrogen phosphate, pyrophosphoric acid, sodium pyrophosphate and hypophosphorous acid. The protonic acid solution has a concentration of 0.5 to 3 mol/L.

The technical solution of the present application has the following advantages:

1. In the positive electrode material provided by the present application, the positive electrode material includes polyanion sodium iron salt and graphene coated on the polyanion sodium iron salt, and the positive electrode material is a hollow porous structure. The hollow porous structure cooperates with the graphene coated on the polyanion sodium iron salt, such that the positive electrode material has significantly improved charge-discharge performance and cycle stability. On the one hand, the positive electrode material with a hollow porous structure has many highly open three-dimensional pore passages, which is conducive to the insertion and extraction of large-sized sodium ions, and increases the contact area with the electrolyte at the same time, greatly improving the conductivity and charge-discharge performance, and effectively avoiding the structure of the positive electrode material of the sodium battery being damaged during the rapid insertion and extraction of sodium ions. Moreover, the graphene coated on the outer surface of the polyanionic sodium iron salt can greatly increase the bonding force of the material on the current collector, the flexibility and ductility of the positive electrode plate, and improve the structural stability, thereby improving the cycle stability.

2. In the positive electrode material provided by the present application, the positive electrode material is a hollow and porous spherical structure. When the inner diameter of the positive electrode material is controlled to be 0.5-9 μm, and the wall thickness is controlled to be 1-13 μm, especially when the inner diameter is controlled to be 1-5 μm, and the wall thickness is controlled to be 2-5 μm, the structural stability of the positive electrode material can be further improved, thereby improving the cycle performance and rate capability of the material.

3. In the positive electrode material provided by the present application, the positive electrode material has a hollow and porous spherical structure. When the pore diameter of the positive electrode material is controlled to be 50-500 nm, the porosity is controlled to be 3-18%, and the specific surface area is controlled to be 5-40 m²/g, especially when the pore diameter of the positive electrode material is controlled to be 100-300 nm, the porosity is controlled to be 5-12%, and the specific surface area is controlled to be 10-30 m²/g, the structural stability and rate capability of the material can be further improved.

4. In the preparation method for the positive electrode material provided by the present application, a base solution is prepared by mixing carbon spheres with water, an anion source, an alkaline solution and a metal solution containing iron salts are added to the base solution, to perform a precipitation reaction, and a sodium salt is added to obtain a precursor solution. The graphene is disposed in a vacuum environment to obtain a graphene film, and the precursor solution is electrosprayed onto the graphene film and the graphene film is calcined to obtain a positive electrode material. Taking a carbon spheres solution as a base solution, a precursor solution of the polyanion sodium iron salt is prepared on the carbon spheres by precipitation reaction, and a graphene-coated precursor of the polyanion sodium iron salt is prepared by electrospraying, in which the polyanion sodium iron salt covers the carbon spheres, and the graphene is in the outermost layer of the material. The carbon spheres are removed by calcination to obtain a positive electrode material with a hollow porous structure, and the preparation method is simple and convenient.

5. In the preparation method for the positive electrode material provided by the present application, the calcining conditions are controlled, that is, the calcining is carried out by heating up to 350-450° C. at a heating rate of 0.5-2° C./min in a nitrogen atmosphere, maintaining a temperature of 350-450° C. and calcining for 3-5 h, then heating up to 650-850° C. at a heating rate of 0.5-2° C./min, and maintaining a temperature of 650-850° C. and calcining for 5-20 h, preferably, the calcining is carried out by heating up to 380-420° C. at a heating rate of 0.8-1.5° C./min in a nitrogen atmosphere, maintaining a temperature of 380-420° C. and calcining for 3-5 h, then heating up to 680-720° C. at a heating rate of 0.8-1.5° C./min, and maintaining a temperature of 680-720° C. and calcining for 8-12 h; so that the pore diameter, porosity and specific surface area of the positive electrode material are within the preferred range, and the capacity, cycle stability and rate capability of the positive electrode material are further improved.

6. In the preparation method for the positive electrode material provided by the present application, a ratio of a molar amount of phosphate ions in the phosphorus source to a molar amount of hydrogen ions in the protonic acid to a total molar amount of metal elements added in the base solution is 2-4:1-2:1-3. This ratio can ensure that there are excess phosphate radicals that can generate pyrophosphate radicals at a later high temperature, which can further improve the stability of the material structure and provide a channel for the insertion and extraction of sodium ions, increasing the capacity of the material.

### BRIEF DESCRIPTION OF THE DRAWINGS

In order to illustrate the technical solutions in the detailed specification of the present application or in the prior art more clearly, the accompanying drawings that need to be used in the detailed specification of the present application or in the prior art will be introduced hereinafter. Obviously, the accompanying drawings described below are some embodiments of the present application. For those ordinary skilled in the art, other accompanying drawings can also be obtained based on these accompanying drawings without creative efforts.

FIG. 1 is the infrared spectrogram of the positive electrode material obtained in Example 1;

FIG. 2 is the TEM image of the positive electrode material obtained in Example 1;

FIG. 3 is the SEM image of the positive electrode material obtained in Example 1;

FIG. 4 is a cycle performance diagram of the positive electrode material obtained in Experimental Example 3 of Example 1 at 0.2C, 1C and 5C rates; and

FIG. 5 is the XRD pattern of the positive electrode material obtained in Example 1.

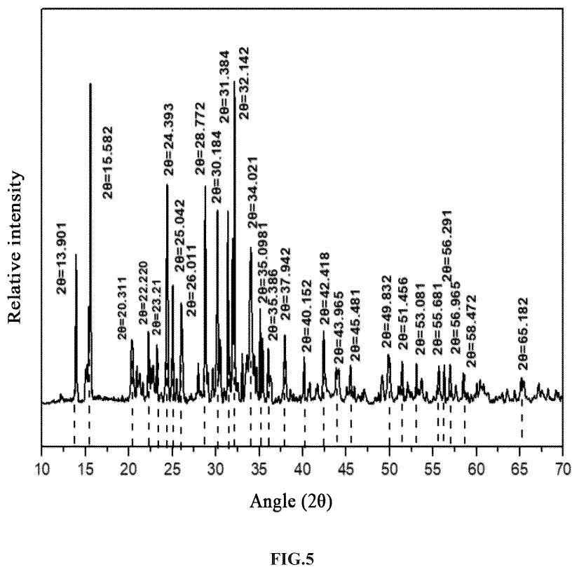

### DETAILED DESCRIPTION OF PREFERRED EMBODIMENTS

The present application will be better understood from the following examples, and is not limited to the optimum embodiments, and the content and protection scope of the present application are not limited. Any product identical or similar to the present application obtained by anyone under the teaching of the present application or by combining the present application with the features of other prior art shall fall within the protection scope of the present application.

One that is not indicated for the specific experimental steps or conditions in the examples, can be carried out according to the operations or conditions of the conventional experimental steps described in the literature in the present field. The reagents or instruments used without the manufacturer's indication are all conventional reagent products that can be obtained from the market. The carbon spheres were purchased from Xianfeng Nanomaterial Company, with model numbers of XF252, XFP12, XFP13, XFP14, and XFP05, and the average particle size is 0.5 micron, 1 micron, 2 micron, 4 micron and 8 micron, respectively.

### Example 1

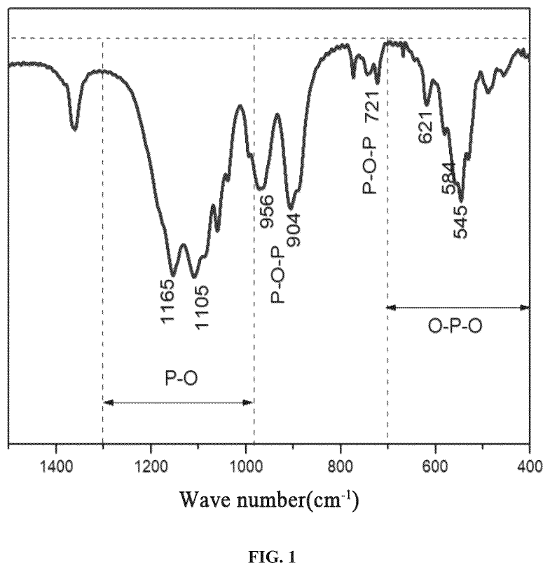

This example provides a positive electrode material. The positive electrode material includes a polyanion sodium iron salt and graphene coated on the polyanion sodium iron salt. In particular, referring to FIG. 1, this positive electrode material is P—O—P bond binding at wave numbers of 721 cm⁻¹-956 cm⁻¹, corresponding to P₂O₇ group, namely pyrophosphate group; while 400-700 cm⁻¹ and 975-1300 cm⁻¹ are O—P—O and P—O bond binding, respectively, corresponding to PO₄ group, namely phosphate group. The molecular formula of the polyanionic sodium iron salt is Na₄(Fe_{0.6}Mn_{0.392}La_{0.08})₃(PO₄)₂P₂O₇.

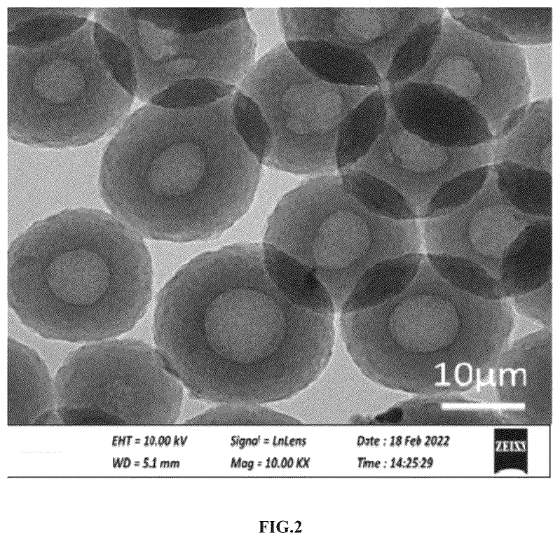

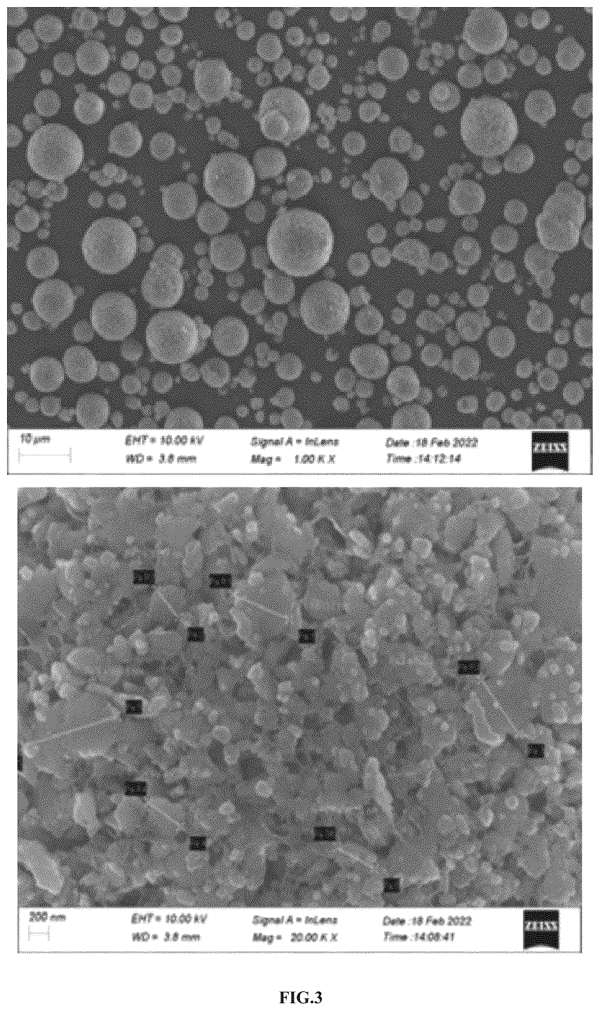

Referring to FIG. 2 and FIG. 3, TEM and SEM images confirm that the positive electrode material is a hollow and porous spherical structure, and the inner diameter, wall thickness, pore diameter, porosity and specific surface area of the positive electrode material are shown in Table 2.

The preparation method for the positive electrode material includes the following steps:
(1) ferric sulfate, manganese sulfate and lanthanum sulfate were mixed in a molar ratio of metal elements of 0.6:0.392:0.08, and water was added to obtain a metal solution with a total mass concentration of metal salts of 1.2 mol/L. Using pure water as a solvent, 1 mol/L ammonium dihydrogen phosphate solution, 0.5 mol/L ammonia water solution and 1 mol/L citric acid aqueous solution were prepared, respectively. Carbon spheres with a particle size of 2 μm were added to pure water as seed crystals, and stirred at 400 rpm for 10 min to obtain a base solution with a concentration of 100 g/L. The metal solution, the ammonium dihydrogen phosphate solution and the citric acid aqueous solution were added to the base solution at dropping rates of 200 ml/min, 300 ml/min and 60 ml/min, respectively, and the dropping period for the three solutions were all 20 hours. During the reaction, ammonia water solution was added to control the pH value of the reaction system to be 2.5, the stirring rate was controlled at 700 rpm, and the temperature was controlled at 90° C. After the dropwise addition, the reaction was completed. Then sodium carbonate was added according to a Na:(Fe+Mn+La) molar ratio of 4:3, and stirred at 700 rpm for 1 h to obtain a precursor solution. After drying, water was added to obtain a precursor solution with a solid content of 500 g/L.
(2) 48 g graphene was disposed in a vacuum vessel to obtain a graphene film, then 2 L of the precursor solution with a solid content of 500 g/L was sprayed on the graphene film using a electrospray method, with a electrospray speed of 6 ml/h, a spraying voltage of 15 KV, a spray nozzle diameter of 10 μm, and a temperature of the discharge port of 80° C., which can ensure the slow drying of the mixture, and a dry product was obtained. The dry product was calcined in a tube furnace in a nitrogen atmosphere, heated up to 400° C. at a heating rate of 1° C./min, maintained at this temperature and calcined for 4 hours, and then heated up to 700° C. at a heating rate of 1° C./min, maintained at this temperature and calcined for 10 h, and the nitrogen atmosphere was 1 L/min; the calcined material was sieved with a 400-mesh sieve to obtain 646.3 g of positive electrode material.

### Example 2

This example provides a positive electrode material and a preparation method thereof, and the preparation method for the positive electrode material includes the following steps:

(1) ferric sulfate, manganese sulfate and lanthanum sulfate were mixed in a molar ratio of metal elements of 0.6:0.392:0.08, and water was added to obtain a metal solution with a total mass concentration of metal salts of 1.3 mol/L. Using pure water as a solvent, 1.2 mol/L sodium dihydrogen phosphate solution, 1 mol/L ammonia water solution and 1.2 mol/L citric acid aqueous solution were prepared, respectively. Carbon spheres with a particle size of 1 μm were added to pure water as seed crystals, and stirred at 400 rpm for 10 min to obtain a base solution with a concentration of 150 g/L. The metal solution, sodium dihydrogen phosphate solution and citric acid were added to the base solution at dropping rates of 100 ml/min, 250 ml/min and 50 ml/min, respectively, and the dropping period for the three solutions were all 15 hours. During the reaction, ammonia water solution was added to control the pH value of the reaction system to be 3.2, the stirring rate was controlled at 600 rpm, and the temperature was controlled at 100° C. After the dropwise addition, the reaction was completed. Then sodium carbonate was added according to a Na:(Fe+Mn+La) molar ratio of 4:3, and stirred at 700 rpm for 1 h to obtain a precursor solution. After drying, water was added to obtain a precursor solution with a solid content of 500 g/L.

(2) 6 g graphene was disposed in a vacuum vessel to obtain a graphene film, then 2 L of the precursor solution with a solid content of 500 g/L on the graphene film using a electrospray method, with a electrospray speed of 10 ml/h, a spraying voltage of 20 KV, a spray nozzle diameter of 10 μm, and a temperature of the discharge port of 70° C., which can ensure the slow drying of the mixture, and a dry product was obtained. The dry product was calcined in a tube furnace in a nitrogen atmosphere, heated up to 380° C. at a heating rate of 1.5° C./min, maintained at this temperature and calcined for 4 h, and then heated up to 720° C. at a heating rate of 0.8° C./min, maintained at this temperature and calcined for 12 h, and the nitrogen atmosphere was 1 L/min; the calcined material was sieved with a 400-mesh sieve to obtain 603.6 g of positive electrode material.

### Example 3

This example provides a positive electrode material and a preparation method thereof, and the preparation method for the positive electrode material includes the following steps:
(1) ferric sulfate, manganese sulfate and lanthanum sulfate were mixed in a molar ratio of metal elements of 0.6:0.392:0.08, and water was added to obtain a metal solution with a total mass concentration of metal salts of 0.9 mol/L. Using pure water as solvent, 0.8 mol/L ammonium dihydrogen phosphate solution, 1.5 mol/L ammonia water solution and 1.5 mol/L citric acid aqueous solution were prepared, respectively. Carbon spheres with a particle size of 4 μm were added to pure water as seed crystals, and stirred at 400 rpm for 10 min to obtain a base solution with a concentration of 100 g/L. The metal solution, ammonium dihydrogen phosphate solution and citric acid were added to the base solution at dropping rates of 200 ml/min, 380 ml/min and 50 ml/min, respectively, and the dropping period for the three solutions were all 20 hours. During the reaction, ammonia water solution was added to control the pH value of the reaction system to be 2.5, the stirring rate was controlled at 800 rpm, and the temperature was controlled at 80° C. After the dropwise addition, the reaction was completed, then sodium carbonate was added according to a Na:(Fe+Mn+La) molar ratio of 4:3, and stirred at 700 rpm for 1 h to obtain a precursor solution. After drying, water was added to obtain a precursor solution with a solid content of 500 g/L.
(2) 120 g graphene was disposed in a vacuum vessel to obtain a graphene film, then 2 L of the precursor solution with a solid content of 500 g/L was sprayed on the graphene film using a electrospray method, with a electrospray speed of 4 ml/h, a spraying voltage of 10 KV, a spray nozzle diameter of 10 μm, and a temperature of the discharge port of 80° C., which can ensure the slow drying of the mixture, and a dry product was obtained. The dry product was calcined in a tube furnace in a nitrogen atmosphere, heated up to 400° C. at a heating rate of 0.8° C./min, maintained at this temperature and calcined for 4 h, and then heated up to 700° C. at a heating rate of 1.5° C./min, maintained at this temperature and calcined for 8 h, and the nitrogen atmosphere was 1 L/min; the calcined material was sieved with a 400-mesh sieve to obtain 718.5 g of positive electrode material.

### Example 4

This example provides a positive electrode material and a preparation method thereof, which were basically the same as those in Example 1, except that carbon spheres with a particle size of 8 μm are used in step (1), and the dropping period for the three solutions were all 60 h, 530.3 g of positive electrode material was obtained.

### Example 5

This example provides a positive electrode material and a preparation method thereof, which were basically the same as those in Example 1, except that carbon spheres with a particle size of 0.5 μm were used in step (1), and the dropping period for the three solutions were all 5 h, 658.2 g of positive electrode material was obtained.

### Example 6

This example provides a positive electrode material and a preparation method thereof, which were basically the same as those in Example, except that the calcination in step (2) was heating up to 400° C. at a heating rate of 1° C./min, maintaining this temperature and calcining for 4 hours, and then heating up to 700° C. at a heating rate of 1° C./min, and maintaining this temperature and calcining for 20 h, in a nitrogen atmosphere of 1 L/min, to obtain 634.5 g of positive electrode material.

### Example 7

This example provides a positive electrode material and a preparation method thereof, which were basically the same as those in Example, except that the calcination in step (2) is heating up to 400° C. at a heating rate of 1° C./min, maintaining this temperature and calcining for 4 hours, and then heating up to 700° C. at a heating rate of 1° C./min, and maintaining this temperature and calcining for 5 h, in a nitrogen atmosphere of 1 L/min, to obtain 647.3 g of positive electrode material.

### Example 8

This example provides a positive electrode material, the positive electrode material includes a polyanion sodium iron salt and graphene coated on the polyanion sodium iron salt, and the molecular formula of the polyanion sodium iron salt is Na₄Fe₃(PO₄)₂P₂O₇. The preparation method includes the following steps:
(1) water was added to ferric sulfate to obtain a metal solution with a concentration of ferric sulfate of 1.2 mol/L. Using pure water as a solvent, 1 mol/L ammonium dihydrogen phosphate solution, 0.5 mol/L ammonia water solution and 1 mol/L citric acid aqueous solution were prepared, respectively. Carbon spheres with a particle size of 2 μm were added to pure water as seed crystals, and stirred at 400 rpm for 10 min to obtain a base solution with a concentration of 100 g/L. The metal solution, the ammonium dihydrogen phosphate solution and the citric acid aqueous solution were added to the base solution at dropping rates of 200 ml/min, 300 ml/min and 60 ml/min, respectively, meanwhile ammonia water solution was added to control the pH value of the reaction system to be 2.5, the stirring rate was controlled at 700 rpm, the temperature was controlled at 90° C., and the dropping period for the three solutions were all 20 hours. After the reaction was completed, sodium carbonate was added according to a Na:(Fe) molar ratio of 4:3, and stirred at 700 rpm for 1 h to obtain a precursor solution. After drying, water was added to obtain a precursor solution with a solid content of 500 g/L.
(2) 78.64 g graphene was disposed in a vacuum vessel to obtain a graphene film, then 2 L of the precursor solution with a solid content of 500 g/L was sprayed on the graphene film using a electrospray method, with a electrospray speed of 6 ml/h, a spraying voltage of 15 KV, a spray nozzle diameter of 10 μm, and a temperature of the discharge port of 80° C., which can ensure the slow drying of the mixture, and a dry product was obtained. The dry product was calcined in a tube furnace in a nitrogen atmosphere, heated up to 400° C. at a heating rate of 1° C./min, maintained at this temperature and calcined for 4 hours, and then heated up to 700° C. at a heating rate of 1° C./min, maintained at this temperature and calcined for 10 h, and the nitrogen atmosphere was 1 L/min; the calcined material was sieved with a 400-mesh sieve to obtain a positive electrode material, and 1031.4 g of the positive electrode material was obtained.

### Example 9

This example provides a positive electrode material, the positive electrode material includes polyanion sodium iron salt and graphene coated on the polyanion sodium iron salt, and the molecular formula of the polyanion sodium iron salt is Na₄(Fe_{0.6}Co_{0.392}Y_{0.08})₃(SO₄)₂P₂O₇. The preparation method includes the following steps:
(1) ferric sulfate, cobalt sulfate and yttrium sulfate were mixed in a molar ratio of metal elements of 0.6:0.392:0.08, and water was added to obtain a metal solution with a total mass concentration of metal salts of 1.2 mol/L. Using pure water as a solvent, 1 mol/L ammonium dihydrogen phosphate solution, 0.5 mol/L ammonia water solution, 1 mol/L citric acid aqueous solution and 1 mol/L ammonium sulfate solution were prepared, respectively. Carbon spheres with a particle size of 2 μm were added to pure water as seed crystals, and stirred at 400 rpm for 10 min to obtain a base solution with a concentration of 100 g/L. The metal solution, ammonium dihydrogen phosphate solution, citric acid and ammonium sulfate solution were added to the base solution at dropping rates of 200 ml/min, 300 ml/min, 60 ml/min and 60 ml/min, respectively, meanwhile ammonia water solution was also added to control the pH value of the reaction system to be 2.5, the stirring rate was controlled at 700 rpm, the temperature was controlled at 90° C., the dropping period for the three solutions were all 20 hours, and the reaction was completed. After the reaction was completed, sodium carbonate was added according to a Na:(Fe) molar ratio of 4:3, and stirred at 700 rpm for 1 h to obtain a precursor solution. After drying, water was added to obtain a precursor solution with a solid content of 500 g/L.
(2) 44.5 g graphene was disposed in a vacuum vessel to obtain a graphene film, then 2 L of the precursor solution with a solid content of 500 g/L was sprayed on the graphene film using a electrospray method, with a electrospray speed of 6 ml/h, a spraying voltage of 15 KV, a spray nozzle diameter of 10 μm, and a temperature of the discharge port of 80° C., which can ensure the slow drying of the mixture, and a dry product was obtained. The dry product was calcined in a tube furnace in a nitrogen atmosphere, heated up to 200° C. at a heating rate of 1° C./min, maintained at this temperature and calcined for 4 h, and then heated up to 500° C. at a heating rate of 1° C./min, maintained at this temperature and calcined for 10 h, and the nitrogen atmosphere was 1 L/min; the calcined material was sieved with a 400-mesh sieve to obtain 596.8 g of positive electrode material.

### Example 10

This example provides a positive electrode material and a preparation method thereof, which were basically the same as those in Example 1, except that the citric acid was not added in step (1), and 649.2 g of positive electrode material was obtained.

### Example 11

This example provides a positive electrode material and a preparation method thereof, which were basically the same as those in Example 1, except that in step (1), citric acid was added dropwise at a rate of 200 ml/min to obtain 640.3 g of positive electrode material.

### Comparative Example 1

This comparative example provides a positive electrode material, which includes the following steps:
(1) ferric sulfate, manganese sulfate and lanthanum sulfate were mixed in a molar ratio of metal elements of 0.6:0.392:0.08, and water was added to obtain a metal solution with a total mass concentration of metal salts of 1.2 mol/L. Using pure water as a solvent, 1 mol/L ammonium dihydrogen phosphate solution, 0.5 mol/L ammonia water solution and 1 mol/L citric acid aqueous solution were prepared, respectively. The metal solution, the ammonium dihydrogen phosphate solution and the citric acid aqueous solution were added to the pure water at dropping rates of 200 ml/min, 300 ml/min and 60 ml/min, respectively, and the dropping period for the three solutions were all 20 hours. During the reaction, ammonia water solution was added to control the pH value of the reaction system to be 2.5, the stirring rate was controlled at 700 rpm, and the temperature was controlled at 90° C. After the reaction was completed, sodium carbonate was added according to a Na:(Fe+Mn+La) molar ratio of 4:3, and stirred at 700 rpm for 1 h to obtain a precursor solution. After drying, water was added to obtain a precursor solution with a solid content of 500 g/L.
(2) 48 g graphene was disposed in a vacuum vessel to obtain a graphene film, then 2 L of the precursor solution with a solid content of 500 g/L was sprayed on the graphene film using a electrospray method, with a electrospray speed of 6 ml/h, a spraying voltage of 15 KV, a spray nozzle diameter of 10 μm, and a temperature of the discharge port of 80° C., which can ensure the slow drying of the mixture, and a dry product was obtained. The dry product was calcined in a tube furnace in a nitrogen atmosphere, heated up to 400° C. at a heating rate of 1° C./min, maintained at this temperature and calcined for 4 hours, and then heated up to 700° C. at a heating rate of 1° C./min, maintained at this temperature and calcined for 10 h, and the nitrogen atmosphere was 1 L/min; the calcined material was sieved with a 400-mesh sieve to obtain a positive electrode material.

### Comparative Example 2

This example provides a positive electrode material, including the following steps:
(1) ferric sulfate, manganese sulfate and lanthanum sulfate were mixed in a molar ratio of metal elements of 0.6:0.392:0.08, and water was added to obtain a metal solution with a total mass concentration of metal salts of 1.2 mol/L. Using pure water as a solvent, 1 mol/L ammonium dihydrogen phosphate solution, 0.5 mol/L ammonia water solution and 1 mol/L citric acid aqueous solution were prepared, respectively. Carbon spheres with a particle size of 2 μm were added to pure water as seed crystals, and stirred at 400 rpm for 10 min to obtain a base solution with a concentration of 100 g/L. The metal solution, the ammonium dihydrogen phosphate solution and the citric acid aqueous solution were added to the base solution at dropping rates of 200 ml/min, 300 ml/min and 60 ml/min, respectively, and the dropping period for the three solutions were all 20 hours. During the reaction, ammonia water solution was added to control the pH value of the reaction system to be 2.5, the stirring rate was controlled at 700 rpm, and the temperature was controlled at 90° C. After the reaction was completed, sodium carbonate was added according to the Na:(Fe+Mn+La) molar ratio of 4:3, and stirred at 700 rpm for 1 h to obtain a precursor solution. After drying, water was added to obtain a precursor solution with a solid content of 500 g/L.
(2) The precursor solution was spray-dried, placed in a tube furnace for calcination in a nitrogen atmosphere, heated up to 400° C. at a heating rate of 1° C./min, maintained at this temperature and calcined for 4 h, and then heated up to 700° C. at a heating rate of 1° C./min, maintained at this temperature and calcined for 10 h, and the nitrogen atmosphere was 1 L/min; the calcined material was sieved with a 400-mesh sieve to obtain the positive electrode material.

### Comparative Example 3

This comparative example provides a positive electrode material, which includes the following steps:
(1) ferric sulfate, manganese sulfate and lanthanum sulfate were mixed in a molar ratio of metal elements of 0.6:0.392:0.08, and water was added to obtain a metal solution with a total mass concentration of metal salts of 1.2 mol/L. Using pure water as a solvent, 1 mol/L ammonium dihydrogen phosphate solution, 0.5 mol/L ammonia water solution and 1 mol/L citric acid aqueous solution were prepared, respectively. The metal solution, the ammonium dihydrogen phosphate solution and the citric acid aqueous solution were added to the pure water at dropping rates of 200 ml/min, 300 ml/min and 60 ml/min, respectively, and the dropping period for the three solutions were all 20 hours. Ammonia water solution was added to control the pH value of the reaction system to be 2.5, the stirring rate was controlled at 700 rpm, and the temperature was controlled at 90° C. After the reaction was completed, sodium carbonate was added according to a Na:(Fe+Mn+La) molar ratio of 4:3, and stirred at 700 rpm for 1 h to obtain a precursor solution. After drying, water was added to obtain a precursor solution with a solid content of 500 g/L.
(2) The precursor solution was spray-dried, placed in a tube furnace for calcination in a nitrogen atmosphere, heated up to 400° C. at a heating rate of 1° C./min, maintained at this temperature and calcined for 4 h, and then heated up to 700° C. at a heating rate of 1° C./min, maintained at this temperature and calcined for 10 h, and the nitrogen atmosphere was 1 L/min; the calcined material was sieved with a 400-mesh sieve to obtain the positive electrode material.

### ICP Test Results of the Sample of Experimental Example 1

ICP elemental analysis was performed on the positive electrode material of Example 1, and the results are shown in the following table.

TABLE 1
test of each element content

| | Contents in mass |
|---|---|
| Elements | percentage |
| Na | 14.59% |
| Fe | 15.91% |
| Mn | 10.23% |
| La | 5.45% |
| P | 19.65% |

It can be seen from Table 1 and FIG. 1 that the chemical formula of the polyanion sodium iron salt in the positive electrode material prepared in Example 1 is: Na₄(Fe_{0.6}Mn_{0.392}La_{0.08})₃(PO₄)₂P₂O₇.

### Experimental Example 2 Physicochemical Properties and Electrical Properties of Positive Electrode Materials

Test method: the inner diameter and wall thickness of the positive electrode material were tested by adopting the transmission electron microscope, the pore diameter, porosity and specific surface area of the positive electrode material were tested by adopting the specific surface area testing instrument. The results are shown in Table 2.

TABLE 2
physicochemical properties of positive electrode materials

| | | | | | Specific |
|---|---|---|---|---|---|
| | Inner | Wall | Pore | | surface |
| | diame- | thickness | diameter | | area |
| | ter(μm) | (μm) | (nm) | Porosity(%) | (m²/g) |
| Example 1 | 2.10 | 4.30 | 151.21 | 8.51 | 25.31 |
| Example 2 | 1.08 | 3.52 | 156.45 | 8.92 | 26.44 |
| Example 3 | 4.05 | 4.21 | 140.20 | 7.63 | 24.15 |
| Example 4 | 8.21 | 4.12 | 162.35 | 7.32 | 23.25 |
| Example 5 | 0.51 | 4.21 | 152.56 | 7.38 | 23.65 |
| Example 6 | 2.52 | 4.36 | 182.21 | 15.53 | 28.62 |
| Example 7 | 2.55 | 4.21 | 110.32 | 5.01 | 16.62 |
| Example 8 | 2.87 | 4.61 | 152.53 | 8.32 | 24.83 |
| Example 9 | 2.63 | 4.75 | 132.62 | 6.43 | 21.25 |
| Example 10 | 2.12 | 4.81 | 149.52 | 8.92 | 26.63 |
| Example 11 | 2.25 | 4.54 | 151.63 | 8.52 | 24.52 |
| Comparative | 0.23 | 4.05 | 0.45 | 0.32 | 1.25 |
| example 1 | | | | | |
| Comparative | 1.03 | 4.02 | 40.32 | 2.12 | 3.32 |
| example 2 | | | | | |
| Comparative | 0.31 | 4.13 | 20.32 | 0.42 | 3.25 |
| example 3 | | | | | |

The pore diameter a (nm), porosity b %, and specific surface area c (m²/g) of the positive electrode materials of the examples of the present application satisfy the following relational formula: 200<a×c/b<800, which have good electrical properties.

Button cells were assembled using the positive electrode materials obtained in the examples and comparative examples by the following process: the positive electrode material, conductive carbon black and binder polyvinylidene fluoride (PVDF) were mixed in a mass ratio of 90:5:5, and formulated as a slurry by using N-methyl pyrrolidone (NMP) as a solvent, the solid content of the slurry was 65%, and the slurry was evenly coated on an aluminum foil. After drying, it was compacted, with a compacted surface density of 2.2 g/cm³. Vacuum-drying was performed at 120° C. for 12 h to obtain a positive electrode sheet. The negative electrode was a metal lithium sheet, the diaphragm was a polypropylene porous film, and the electrolyte was 1 mol/L NaPF₆/EC+DEC+DMC (EC:DEC:DMC=1:1:1 volume ratio).

The specific capacity was determined under 0.1C (120 mA/g), a voltage range of 1.5 V-4.05 V; and under 5C, a voltage range of 1.5 V-4.05 V; and under 2C, a voltage range of 1.5 V-4.05 V.

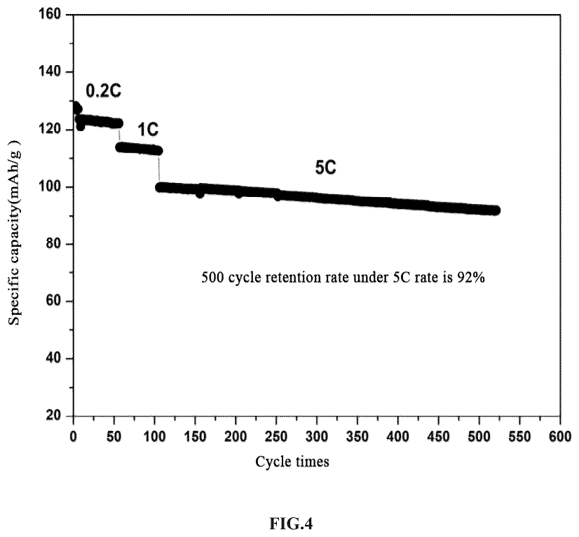

The cycle performance was determined under 0.2C, 1C and 5C, a voltage range of 1.5 V-4.05 V. The positive electrode material of Example 1 was tested at room temperature for 500 cycles, see FIG. 4.

The positive electrode materials of each example and the comparative example were tested at room temperature, under 1C and a voltage range of 1.5 V-4.05 V, see the table below.

TABLE 3
Performance parameters of positive electrode materials

| | | | 500 cycle | |
|---|---|---|---|---|
| | Discharge | Discharge | retention | Discharge |
| | capacity | capacity | rate | capacity |
| | under | under | under | under |
| Runs | 0.1 C(mAh/g) | 5 C(mAh/g) | 1 C(%) | 2 C(mAh/g) |
| Example 1 | 128.5 | 98.6 | 99.5 | 110.2 |
| Example 2 | 122.2 | 97.3 | 98.4 | 108.3 |
| Example 3 | 127.3 | 96.3 | 98.3 | 105.3 |
| Example 4 | 120.3 | 90.2 | 95.3 | 100.3 |
| Example 5 | 122.1 | 89.3 | 93.2 | 94.3 |
| Example 6 | 121.9 | 91.1 | 90.2 | 101.3 |
| Example 7 | 120.3 | 83.2 | 95.2 | 96.2 |
| Example 8 | 125.3 | 96.3 | 98.4 | 102.3 |
| Example 9 | 126.4 | 94.3 | 97.3 | 101.5 |
| Example 10 | 121.1 | 91.2 | 99.2 | 95.3 |
| Example 11 | 123.2 | 92.1 | 90.2 | 97.1 |
| Comparative | 110.2 | 55.3 | 82.6 | 71.62 |
| example 1 | | | | |
| Comparative | 109.2 | 62.2 | 86.1 | 78.2 |
| example 2 | | | | |
| Comparative | 70.5 | 33.2 | 62.1 | 50.2 |
| example 3 | | | | |

The positive electrode materials obtained in Examples 1-11 of the present application include polyanion sodium iron salt and graphene coated on the polyanion sodium iron salt. And it can be seen from Table 2 that the positive electrode material is a hollow porous structure, and these positive electrode materials have significantly improved discharge capacity, cycle stability and rate capability, compared to those of Comparative example 1-3.

Comparing Example 1 with Examples 8 and 9, the capacity, cycle stability and the rate capability are further improved by controlling the types of metal elements in a preferred range, especially by controlling the molecular formula of polyanion sodium iron salt is NaₓFe_{y}Mn_{q}Laᵣ(PO₄)_{z}(P₂O₇)ₘ, where 3≤x≤4, 1.5≤y≤2, 1≤q≤1.5, 0.2≤r≤0.3, and y+q+r≤3, 1≤z≤2, 1≤m≤2.

Comparing Example 1 with Examples 4-5, by optimizing the particle size of the carbon spheres and controlling the dropping period within a preferred range, the inner diameter and wall thickness of the positive electrode material are within the preferred range of the present application, so that the capacity, the cycle stability and the rate capability are further improved.

Comparing Example 1 with Examples 6-7, by controlling the conditions of the calcination reaction, the pore diameter, porosity and specific surface area of the positive electrode material are within a preferred range, so that the capacity, cycle stability and the rate capability are further improved.

Comparing Example 1 with Examples 10-11, in Example 1, by controlling the total molar ratio of the molar amount of phosphate ion in the phosphorus source added in the base solution to the molar amount of hydrogen ion in the protonic acid to the metal element added in the base solution within a preferred range, the pyrophosphate and phosphate coexist in the calcined positive electrode material, so that the capacity, cycle stability and the rate capability of the positive electrode material are further improved.

### XRD Pattern of the Sample of Example 3

The positive electrode material of Example 1 was tested by an X-ray diffractometer, it is a monoclinic phase structure, the space group is Pn2₁a; it has the following unit cell parameters, a=17.9675 Å, b=6.5402 Å, c=10.6672 Å. The unit cell expansion rate is 2.12%. The XRD pattern of the positive electrode material includes diffraction peaks as shown by the following 2θ angles:

TABLE 4
Structural parameters of positive electrode materials

| Peak runs | Angle(2θ) | Relative intensity(%) |
|---|---|---|
| 1 | 13.901 | 5.35 |
| 2 | 15.582 | 12.23 |
| 3 | 20.311 | 2.29 |
| 4 | 22.220 | 2.57 |
| 5 | 23.210 | 2.09 |
| 6 | 24.393 | 7.84 |
| 7 | 25.042 | 4.23 |
| 8 | 26.011 | 3.59 |
| 9 | 28.772 | 7.78 |
| 10 | 30.184 | 2.29 |
| 11 | 31.384 | 6.88 |
| 12 | 32.142 | 11.54 |
| 13 | 34.021 | 5.59 |
| 14 | 35.098 | 3.33 |
| 15 | 35.386 | 2.32 |
| 16 | 37.942 | 2.46 |
| 17 | 40.125 | 1.65 |
| 18 | 42.418 | 2.58 |
| 19 | 43.965 | 1.28 |
| 20 | 45.481 | 1.35 |
| 21 | 49.832 | 1.75 |
| 22 | 51.456 | 1.51 |
| 23 | 53.081 | 1.42 |
| 24 | 55.681 | 1.34 |
| 25 | 56.291 | 1.35 |
| 26 | 56.965 | 1.39 |
| 27 | 58.472 | 1.09 |
| 28 | 65.182 | 0.9 |

The angles of the three strongest peaks are 15.582°, 24.393° and 32.142°. The peak-to-peak intensity ratio of the three strongest diffraction peaks in the XRD of the positive electrode material is 1.56:1:1.47, and the prepared material is a composite pyrophosphate positive electrode material, and has good crystallinity and stable crystal structure.

Obviously, the above-mentioned embodiments are merely provided for a clear description, rather than imposing a limitation thereto. For those ordinary skilled in the art, changes or modifications in other different forms can also be made based on the above description. There is no need to enumerate all embodiments herein, which are cannot be enumerated as well. And the obvious changes or embodiments derived from this are still within the protection scope of the present application.

What is claimed is:

1. A positive electrode material, wherein the positive electrode material comprises a polyanion sodium iron salt and graphene coated on the polyanion sodium iron salt, and the positive electrode material is a hollow porous structure.

2. The positive electrode material according to claim 1, wherein the positive electrode material is a hollow porous spherical structure.

3. The positive electrode material according to claim 1, wherein the positive electrode material has an inner diameter of 0.5-9 μm and a wall thickness of 1-13 μm.

4. The positive electrode material according to claim 1, wherein the positive electrode material has an inner diameter of 1-5 μm and a wall thickness of 2-5 μm.

5. The positive electrode material according to claim 1, wherein the positive electrode material has a pore diameter of 50-500 nm, a porosity of 3-18%, and a specific surface area of 5-40 m²/g.

6. The positive electrode material according to claim 1, wherein the positive electrode material has a pore diameter of 100-300 nm, a porosity of 5-12%, and a specific surface area of 10-30 m²/g.

7. The positive electrode material according to claim 5, wherein the pore diameter a, the porosity b, and the specific surface area c of the positive electrode material satisfy a relational formula below: 200<a×c/b<800.

8. The positive electrode material according to claim 6, wherein the pore diameter a, the porosity b, and the specific surface area c of the positive electrode material satisfy a relational formula below: 200<a×c/b<800.

9. The positive electrode material according to claim 1, wherein the polyanion sodium iron salt has a molecular formula: NaₓFe_{y}M_{q}Bᵣ(AOn)_{z}(P₂O₇)ₘ, where M is at least one selected from the group consisting of Ti, V, Mn, Fe, Co, Ni, Cu and Zn, A is one selected from the group consisting of silicon, phosphorus, sulfur, carbon and boron, B is at least one selected from the group consisting of La, Ce, Pr, Nd, Pm, Sm, Eu, Gd, Td, Dy, Er, Tm, Yb, Lu, Sc, and Y, where 2≤x≤4, 0.5≤y≤3, 0≤q≤2, 0≤r≤0.3, and y+q+r≤3, 0≤z≤3, 0≤m≤3, 1≤n≤4, and z and m are not 0 at the same time, and a chemical formula satisfies charge conservation; preferably, M is Mn, B is La, and A is P.

10. The positive electrode material according to claim 1, wherein the polyanion sodium iron salt has a molecular formula: NaₓFe_{y}Mn_{q}Laᵣ(PO₄)_{z}(P₂O₇)ₘ, where 3≤x≤4, 1.5≤y≤2, 1≤q≤1.5, 0.2≤r≤0.3, and y+q+r≤3, 1≤z≤2, 1≤m≤2.

11. The positive electrode material according to claim 1, wherein a mass of the graphene accounts for 1%-20% of a total mass of the positive electrode material.

12. A preparation method for the positive electrode material according to claim 1, characterized by comprising the following steps:
Step S1: mixing carbon spheres with water to obtain a base solution, adding an anion source, an alkaline solution and a metal solution containing an iron salt to the base solution to perform a precipitation reaction, and adding a sodium salt to obtain a precursor solution;
Step S2: disposing the graphene in a vacuum environment to obtain a graphene film, and electrospraying the precursor solution onto a graphene film, and calcining the graphene film, to obtain the positive electrode material with a hollow porous structure.

13. The preparation method for the positive electrode material according to claim 11, wherein in step S2, the electrospraying has a feeding rate of 4-10 mL/h, a spraying voltage of 10-20 kV, a nozzle diameter of 8-12 μm, and a discharging temperature of 50-90° C.; and/or the calcining is performed at a temperature of 300-800° C. for a period of 5-30 h.

14. The preparation method for the positive electrode material according to claim 12, wherein the calcining is carried out by heating up to 350-450° C. at a heating rate of 0.5-2° C./min in a nitrogen atmosphere, maintaining a temperature of 350-450° C. and calcining for 3-5 h, then heating up to 650-850° C. at a heating rate of 0.5-2° C./min, and maintaining a temperature of 650-850° C. and calcining for 5-20 h.

15. The preparation method for the positive electrode material according to claim 12, wherein the calcining is carried out by heating up to 380-420° C. at a heating rate of 0.8-1.5° C./min in a nitrogen atmosphere, maintaining a temperature of 380-420° C. and calcining for 3-5 h, then heating up to 680-720° C. at a heating rate of 0.8-1.5° C./min, and maintaining a temperature of 680-720° C. and calcining for 8-12 h.

16. The preparation method for the positive electrode material according to claim 12, wherein, step S1 further satisfies at least one of the following (1)-(8):
(1) the metal solution further comprises M salt and/or B salt;
(2) the anion source is at least one selected from the group consisting of silicon source, phosphorus source, sulfur source, carbon source and boron source;
(3) during a precipitation reaction, further comprising a step of adding a protonic acid to the base solution; the anion source is phosphorus source;
(4) during the precipitation reaction, a pH value of a reaction solution is controlled to be 2 to 5; during the precipitation reaction, a stirring speed is controlled to be 500 to 1000 rpm; during the precipitation reaction, a temperature of the reaction solution is controlled to be 70 to 110° C.;
(5) the carbon spheres have a particle size of 0.5-8.0 μm;
(6) the metal solution has a concentration of 0.5-3 mol/L, preferably 0.6-1.5 mol/L; the anion source has a concentration of 0.5-3 mol/L; the metal solution and the anion source are added dropwise to the base solution at a dropping rate of 60-400 mL/h, a time period for a dropwise reaction is 5-60 h;
(7) the alkaline solution is ammonia water;
(8) the base solution has a concentration of 50-200 g/L.

17. The preparation method for the positive electrode material according to claim 15, wherein in (1), M is at least one selected from the group consisting of Ti, V, Mn, Fe, Co, Ni, Cu and Zn; B is at least one selected from the group consisting of La, Ce, Pr, Nd, Pm, Sm, Eu, Gd, Td, Dy, Er, Tm, Yb, Lu, Sc and Y.

18. The preparation method for the positive electrode material according to claim 15, wherein in (2), the anion source is at least one selected from the group consisting of ammonium dihydrogen phosphate, diammonium hydrogen phosphate, triammonium phosphate, phosphoric acid, sodium dihydrogen phosphate, disodium hydrogen phosphate, ammonium sodium hydrogen phosphate, pyrophosphoric acid, sodium pyrophosphate, hypophosphorous acid, ammonium hydrogen carbonate, ammonium sulfate, ammonium borate and ammonium silicate.

19. The preparation method for the positive electrode material according to claim 15, wherein in (3), a ratio of a molar amount of phosphate ions in the phosphorus source added in the base solution to a molar amount of hydrogen ions in the protonic acid to a total molar amount of metal elements added in the base solution is 2-4:1-8:1-3.

20. The preparation method for the positive electrode material according to claim 15, wherein in (4), during the precipitation reaction, a pH value of a reaction solution is controlled to be 2.2 to 3.2; during the precipitation reaction, a stirring speed is controlled to be 600 to 800 rpm; during the precipitation reaction, a temperature of the reaction solution is controlled to be 80 to 100° C.
